(19) United States
(12) Patent Application Publication
(10) Pub. No.: US 2017/0373842 A1
(43) Pub. Date: Dec. 28, 2017

(54) System and Method for Authenticating Public Artworks and Providing Associated Information

(71) Applicant: James Richardson, Edison, NJ (US)

(72) Inventor: James Richardson, Edison, NJ (US)

(21) Appl. No.: 15/120,672

(22) PCT Filed: Jun. 27, 2016
(86) PCT No.: PCT/US2016/039490

§ 371 Date: Aug. 22, 2016

(51) Int. Cl. H04L 9/08; H04W 12/06

(52) U.S. Cl. CPC H04L 9/0847; H04W 12/06

(57) ABSTRACT

Processing artist artwork authentication and published artwork information at a user computing device comprises an artist artwork authentication and artist information system employing a client device configured to use imaged date converted to text to identify an artist central authority server for authenticating published artworks as well as an artwork unique identifier. The artist artwork authentication and artist information system communicates with the central authority server using the identity of the artist central authority server and requests a public key for the central authority server. The client device, upon receiving the public key, then communicates another message to the central authoritative server that includes an encrypted version of the unique identifier that can be used to identify a piece of artwork and an artist associated with the artwork. The client device receives in response receives information regarding the artwork, information relating to the artist, and other information relevant to the artwork.

### TECHNICAL FIELD

The present disclosure relates generally to an authenticating public artworks and providing relevant information about an artwork by capturing imaged data associated with a public artwork and recovering a unique identifier from the captured data and using the unique identifier to securely interface with a central authoritative service for the purpose of authenticating and obtaining relevant information.

### BACKGROUND

Public artworks, originals and replicas, are often disseminated to the public by the artist for monetary value and recognition. The artists primary concern is to get his or her work published, recognized, and ultimately get paid. The issue is that once the artist publishes the work, it then becomes susceptible to fraud, i.e. others can then replicate and potentially profit from the replication at the expense of the artist.

An additional issue, consumers are often presented with artwork, e.g. at an art gallery or even at a home, and the consumer may be actually interested in the artwork present but may not have enough information about the artwork available at the time of viewing or may not know where information about the artwork can be reliably obtained. The information provided with the artwork may not be accurate and there may not be enough resources, e.g. from Internet resources, to provide the consumer with enough information to know the authenticity or other relevant useful information about the public artwork.

As such, there is a need for a system that can function as a central authority to authenticate published artworks and in the same manner provide information about the artwork, its artist, and other relevant information that may be useful for the consumer.

### SUMMARY

Techniques herein provide computer-implemented methods to authenticate and provide relevant information for public artworks. An artwork authentication and information management system uses a client device that is configure to process public artwork assigned unique identifiers captured from imaged data and converted to text and securely communicate a request message for artwork, artist, and information associated with the unique identifier to a central authoritative service. The artwork authentication and information management system uses a server as the central authoritative service and is configured to securely receive and process the request and, in response, sends artist artwork, artist information, and other information to the client device. The client device further configured to receive the response and display relevant artwork and artist information.

In an embodiment, the request message includes a first request message that includes a request for a public key of the central authoritative service. The client device, in response, receives a public key from the central authoritative service and verifies ownership of the public key with a Certificate Authority (CA). The client device, in response to verification, sends a second request message that includes a request for artwork, artist, and other relevant information to the central authoritative service and that also includes an encrypted version of the unique identifier. The client device, in response to the second request message, receives the response that includes the relevant artwork and artist information.

In another embodiment, the request message includes a request for artwork, artist, and other relevant information to the central authoritative server and that also includes an encrypted version of the unique identifier. The client device, in response to the second request message, receives the response that includes the relevant artwork, artist, and other relevant information.

In certain other example aspects described herein, systems and computer program products are utilized to process artist artwork information for user computer devices.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to authenticate public artwork of an artist and provide information about an artist associated with the artwork, in accordance with certain example embodiments.

FIG. 2A is a block flow diagram depicting a method to authenticate public artwork of an artist and provide information about an artist associated with the artwork, in accordance with certain example embodiments.

FIG. 2B is a block flow diagram depicting another method to authenticate public artwork of an artist and provide information about an artist associated with the artwork, in accordance with certain example embodiments.

FIG. 3 is a block diagram depicting a computing machine and system applications, in accordance with certain example embodiments.

### DETAILED DESCRIPTION OF THE EXAMPLE EMBODIMENTS

The object of the described invention is to describe a client and server application system for managing, authenticating, and providing artist and artist artwork information associated with an artist art piece on display in public settings or in private settings.

The motivation for providing such a service is to provide artists with a sense of security in knowing that their artworks on display can be easily determined by the viewing public that the artwork is original and authenticate. In addition, it provides the artist with additional channels to reach out to their audience with information that can facilitate learning more about the artist and other works from the artist. Furthermore, the consumer can easily access information about the displayed artwork and determine its authenticity as well as additional information about the artwork or other artworks that may result in motivating the consumer to purchase the artwork or other artworks or, at minimum, educate the consumer. The additional information can also benefit merchants, e.g. an art gallery that sold the artwork would now have a channel to the consumer to provide catalogs or product offerings.

In an example embodiment, an artist authentication and information management system includes a client device application and a network server application that together operate to authenticate publicly displayed artworks and provide information relevant to the artwork and other useful information. The client device operates to process relevant text data converted from image data captured from public artworks engraved or otherwise labeled with information that can be used to establish secure communications with the server. Once communications is established, the client device and network server interact for the further purpose of authenticating the artwork, providing relevant information about the artwork and artist, and displaying the information.

In an example embodiment, the client device interfaces and receives text data converted from an image captured by 3rd party software of a tag or label engraved or otherwise placed on a frame of a painting, or positioned somewhere near or on the painting, and recovers information, information that includes a unique identifier and a Uniform Resource Locator (URL), used by the client device to communicate with the server for the purpose of requesting a public key associated with the server. The server communicates the public key to the client device. The client device sends the public key and other relevant information to a Certificate Authority (CA) to verify the validity of the public key. Upon verification, the client device encrypts the unique identifier recovered from the information and sends the encrypted unique identifier to the server. The server decrypts the encrypted unique identifier and identifies therefrom an artist and a particular artwork. The server retrieves information associated with the artist and artwork and other non-artist and artwork related information. The server then generates at least one of the an artist information tag, an artwork information tag, an owner information tag, location information tag, and a merchant information tag and associates relevant information with the tags. The server then generates a communications message and populates the communications message with the tags and associated information and communicates the message to the client device. The client device upon receiving the message can then display the contents for the user.

In an example embodiment, the client device captures interfaces and receives text data converted from an image captured by 3rd party software of a tag or label engraved or otherwise placed on a frame of a painting, or positioned somewhere near or on the painting, and recovers information that includes a unique numeric identifier. The client device retrieves a stored uniform resource locater and generates a communications message addressed to the uniform resource locater that identifies the server. The client device encrypts the unique numeric identifier creating an encrypted numeric unique identifier and appends the encrypted unique identifier to the generated communications message. The client device communicates the communication message to the server. The server receives the communication message and decrypts the unique identifier. The server parses the unique identifier and correlates the parsed identifier with an artist name and artist artwork piece. The server retrieves information associated with the artist and artwork and other non-artist and artwork related information. The server then generates at least one of the an artist information tag, an artwork information tag, an owner information tag, location information tag, and a merchant information tag and associates relevant information with the tags. The server then generates a communications message and populates the communications message with the tags and associated information and communicates the message to the client device. The client device upon receiving the message can then display the contents for the user.

By using and relying on the methods and system described herein, the artist artwork authentication and artist artwork publication information system provides a trusted service that authenticates published artworks and provides artist and artist artwork information as well as other art related information to a consumer. As such, the systems and methods described herein may be employed to allow artist public artwork to be authenticated and relevant information provided to consumers publicly viewing these works. For example, a consumer may be viewing art pieces from an art gallery or someone's home and can quickly learn of the authenticity of the art piece, the artist of the art piece, the owner of the art piece, and other useful information. As such, the methods and systems described herein permit an artist to have his or her art piece placed on display that could be easily validated as being authentic and, in addition, provide useful information to the consumer that may facilitate future sales.

### Example System Architectures

Turning now to the drawings, in which like numerals represent like (but not necessarily identical) elements throughout the figures, example embodiments are described in detail.

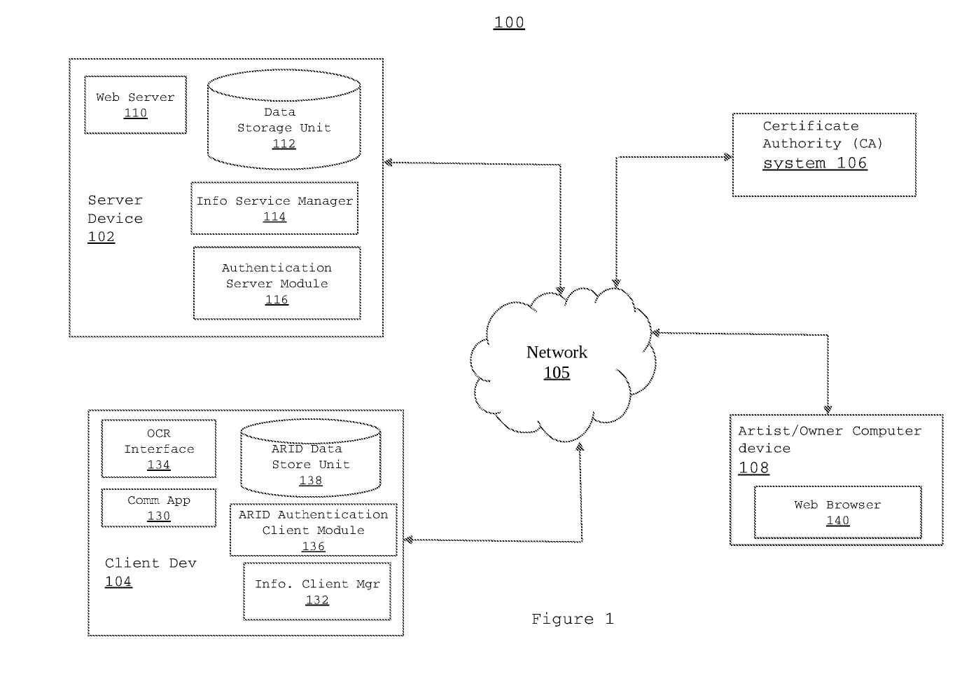

FIG. 1 is a block diagram depicting a system 100 to authenticate public artworks and provide information about the artist of the artwork.

As depicted in FIG. 1, the system 100 includes the following computing devices: a server device 102, client device 104, a Certificate Authority (CA) system 106, and artist/owner computer device 108, all configured to communicate with one another via one or more communication networks 105 or via any suitable communication technology.

Network 105 may include a wired or wireless telecommunication network system by which network devices (including devices 102, 104, 106, and 108) can communicate data. As an example, network 105 can include a local area network (“LAN”), a wide area network (“WAN”), an intranet, an Internet, a mobile telephone network, personal area network (PAN), a metropolitan area network (MAN), a wireless local area network (WLAN), a cellular or other mobile communication network, Bluetooth, NFC, or any combination thereof that facilitates the communication of signals, data. In the discussion of example embodiments, it should be understood that the terms “data” and “information” are used interchangeably herein to refer to text, images, audio, video, or any other form of information that can exist in a computer processing system. The communication technology utilized by devices 102, 104, 106 and 108 may be similar networks to network 105 or an alternative communication technology.

Computing devices 102, 104, 106, and 108 include a computing device having a communication module capable of transmitting and receiving data over the network 105 or similar network. For example, each computing device 104, 104, 106, and 108 can include a server, desktop computer, laptop computer, tablet computer, smart phone, wearable devices such as smart watches, or any other wired or wireless, processor-driven device. In the example embodiment depicted in FIG. 1, the computing devices are operated by users or consumers, artists, art dealers, art owners, and the system providers.

The server system 102 includes web server 120 for communicating using standardized methods with client device 104, CA system 106, and computer device 108 in order to interface artwork authentication and artist information. Although, it should be understood the methods of communications could be proprietary or a combination of standardized and proprietary.

The server system 102 also includes a data storage unit 112, a information service manager 114 and a server authentication module 116 with the web server 110, service manager 114 and authentication module 116 operable to store and access data from the data store unit 112 using commonly known data store, access, and retrieval methods readily available for any open source or commercial database server or file management system.

The data storage unit 112 accessible by the web server 110, the service manager 114, and the authentication module 116 includes one or more tangible computer-readable storage devices for receiving and storing artwork, artist, and other relevant information. The data storage unit 112 can include one or more tangible computer-readable storage devices, or the data storage unit may be a separate system, such as, a different physical or virtual machine, or a cloud-based storage service.

The information service manager 114 receives and stores registration information regarding artist and artist artwork information from the artist or owner of an art piece from artist/owner computer device 108 using, for example, web browser 140 capable of interfacing with web server 110. The artist or owner can register an art piece with server device 102 by submitting relevant information. The relevant information can include, but is not limited to the following: artwork title; artwork artist; completion date; owner; location identifier; artist biography; seller; and seller profile. The owner and location identifier provides a registered artwork disseminated to the consumer with information that the consumer can use to further authenticate a public artwork. The seller profile may include merchant information, e.g. an art gallery, may include links to web site listing further artworks the consumer may be interested in.

The information service manager 114 generates an identifier that, in a first embodiment, comprises a Universal Resource Locater (URL) that identifies the registered domain of server device 102 and a unique identifier that identifies a registered art piece. In a second embodiment, the service manager 114 is operable to generate only a unique identifier. In each case, the unique identifier and, optionally, the URL is provided to the artist/owner computer device 108 for placement, for example as a label, on an art piece. The unique identifier is stored in the storage unit 112 and identifies an art piece and an artist.

The authentication server module 116 may encompass any application, hardware, software, or process the server device 102 may employ to assist the information server manager 114 in generating public and private key pairs for the server device 102 and storing the public and private key pair in the data store unit 112. The public key generated may be provided to client device 104 upon request or may be previously stored, for example during installation of software components, on the client device 104.

A user of client device 104 can use a communication application 130, which may be, for example, a web browser application or another similar type of communication application, to view, download, upload, or otherwise access messages or web pages via network 105. The communication application 130 can interact with web servers or other computing devices connected to network 105, including the web server 110 of the server device 102.

The client device 104 also includes an information client manager 132, an Object Character Recognition (OCR) interface 134, an authentication client module 136, and a data storage unit 138. The OCR interface 134 interface with 3rd party OCR software that can take imaged data captured from a camera and convert it to text for processing by another entity, in this case the OCR interface. OCR interface receives the text data and provides it to the information client manager 132 for processing.

The data storage unit 138 accessible by the client manager 132, the communication application 130, the authentication client module 136, and the OCR interface 134 includes one or more tangible computer-readable storage devices. The data storage unit 138 can be stored on client device 104 or can be logically coupled to client device 104. For example, the data storage unit 138 can include on-board flash memory and/or one or more removable memory accounts or removable flash memory. The data storage unit 138 stores and provides access to artist and artist artwork information.

The OCR interface 134 may encompass any application, hardware, software, or process the client device 104 may employ to assist the client manager 112 in authenticating ownership of artwork and obtaining relevant information by using application protocol interfaces to access 3rd party OCR system services to read, identify and extract relevant information converted from captured image data. The OCR interface 134 may be configured to identify a URL and an unique identifier or only the unique identifier. The OCR interface 134 captures and stores the unique identifier and, optionally, the URL labeled with or otherwise provided in some fashion with a published art piece.

The client manager 132 may encompass any application, hardware, software, or process the client device 104 may employ to assist the user in obtaining information about the authenticity of an art piece and information about its artist, and any other relevant information service device 102 may provide in addition thereto. The client manager 132 retrieves unique identifier and, optionally, the URL from storage unit 138. The client manager 132 interfaces with communication application 130 to interface with server device 102 in order to obtain a public key for the service device 102. The client manager 132 can interact with the authentication client module 136 to verify the obtained public key. It should be understood that if the URL associated with the central authority system, i.e. the server device 102, is not provided by the OCR interface 134, client device 104 can obtain the URL from database 138, e.g. the URL could be pre-stored during installation of application software.

The authentication client module 136 may encompass any application, hardware, software, or process the client device 104 may employ to assist the client manager 132 in authenticating ownership of artwork using information provided by the client manager 132 using either public key infrastructure methods of authentication or a virtual private network. In the former case, the CA system 106 authenticates a public key provided by the server device 102. In the latter case, the client device 104 and server system 102 are trusted systems and, therefore, use securely stored public and private keys to communicate, effectively an established virtual private network.

### Example Processes

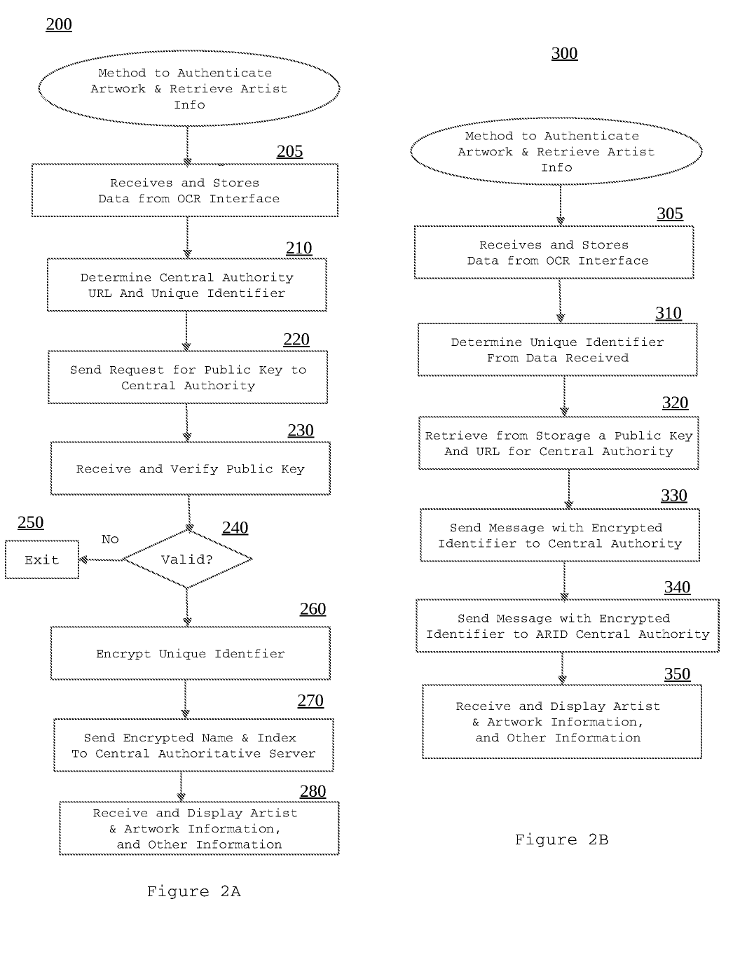

The example methods illustrated in FIGS. 2A and 2B are described hereinafter with respect to the components of the example operating environment 100. The example methods of FIGS. 2A and 2B may also be performed with other systems and in other environments.

FIGS. 2A and 2B are block flow diagrams depicting a first method 200 and a second method 300 for authenticating public artwork and retrieving associated information.

With respect to FIG. 2A, and in reference to FIGS. 1 and 2A, in block 205, the client device 104 receives and stores data from OCR interface 134. In block 210, client device 104 determines central authority URL and unique identifier. At step 220, the client device 104 can generate a communications message addressed with the central authority URL, i.e. the URL of server device 102. The message is then sent along with a request for the public key for server device 102, or web server 110, and the artist identifiable by the unique identifier. At block 230, the public key is received and verified with CA system 106. If the public key is not valid, as determined at step 240, the process is exited, step 250. If it is valid, the unique identifier is encrypted using the public key and included in a communications message addressed to the central authority and sent to server device 102, blocks 260 and 270. At block 280, the information, e.g. artwork information, artist information, other artwork information or vendor or merchant information, returned may be displayed for the user. In addition, some of the information returned may be in the form of an audio file that allows the user to listen to an audio description of an artwork and the artist.

With respect to FIG. 2B, and in reference to FIGS. 1 and 2B, block 305, the OCR interface 134 receives data that includes a unique identifier and stores the unique identifier in data store unit 138. At block 310, the information client manager 132 determines the unique identifier from information stored at block 310. At block 320, the authentication client module 136 retrieves from storage a public key and URL for central authority. At block 330, the authentication client module 136 encrypts the unique identifier using the public key. At block 340, the information client manager 132 generates a communications message addressed to the central authority and includes within the message the encrypted identifier and sends the message with encrypted identifier to the central authority, i.e. server device 102. At block 350, the information, e.g. artwork information, artist information, other artwork information or vendor or merchant information, returned may be displayed for the user. In addition, some of the information returned may be in the form of an audio file that allows the user to listen to an audio description of artwork and its artist.

### Example Systems

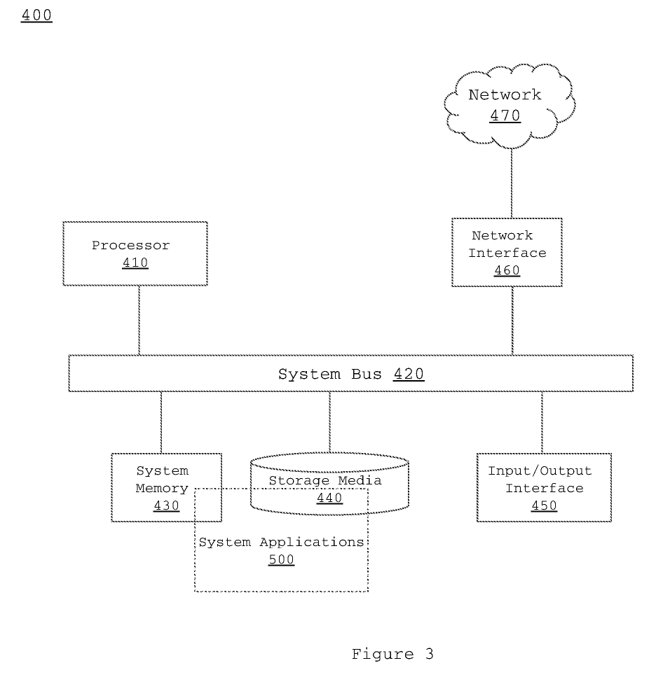

FIG. 3 depicts a computing machine 400 and a system applications module 500 in accordance with example embodiments of the invention. The computing machine 400 may correspond to any of the various computers, servers, mobile devices, embedded systems, or computing systems presented herein. The module 480 may comprise one or more hardware or software elements designed to facilitate the computing machine 480 in performing the various methods and processing functions presented herein. The computing machine 400 may include various internal or attached components such as a processor 410, system bus 420, system memory 430, storage media 440, input/output interface 450, and a network interface 460 for communicating with a network 470.

The computing machine 400 may be implemented as a conventional computer system, an embedded controller, a laptop, a server, a mobile device, a smartphone, a wearable computer, a customized machine, any other hardware platform, or any combination or multiplicity thereof. The computing machine 400 may be a system configured to function using multiple computing machines connected via a data network or bus system.

The processor 410 may be designed to execute code instructions in order to perform the operations and functionality described herein, manage request flow and address mappings, and to perform calculations and generate commands. The processor 410 may be configured to monitor and control the operation of the components in the computing machine 400. The processor 410 may be a single processing unit, multiple processing units, a single processing core, multiple processing cores, special purpose processing cores, co-processors, or any combination thereof. According to certain embodiments, the processor 410 along with other components of the computing machine 400 may be a virtualized computing machine executing within one or more other computing machines.

The system memory 420 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 420 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 420. The system memory 430 may be implemented using a single memory module or multiple memory modules. While the system memory 430 is depicted as being part of the computing machine 400, one skilled in the art will recognize that the system memory 430 may be separate from the computing machine 400 without departing from the scope of the subject technology. It should also be appreciated that the system memory 430 may include, or operate in conjunction with, a non-volatile storage device such as the storage media 440.

The storage media 440 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 440 may store one or more operating systems, application programs and program modules such as module 2050, data, or any other information. The storage media 440 may be part of, or connected to, the computing machine 400. The storage media 440 may also be part of one or more other computing machines that are in communication with the computing machine 400 such as servers, database servers, cloud storage, network attached storage, and so forth.

The system applications module 500 may comprise one or more hardware or software elements configured to facilitate the computing machine 400 with performing the various methods and processing functions presented herein. The module 500 may include one or more sequences of instructions stored as software or firmware in association with the system memory 430, the storage media 440, or both. The storage media 440 may therefore represent examples of machine or computer readable media on which instructions or code may be stored for execution by the processor 410. Machine or computer readable media may generally refer to any medium or media used to provide instructions to the processor 410. Such machine or computer readable media associated with the module 500 may comprise a computer software product. It should be appreciated that a computer software product comprising the module 500 may also be associated with one or more processes or methods for delivering the module 500 to the computing machine 400 via the network 470, any signal-bearing medium, or any other communication or delivery technology. The module 500 may also comprise hardware circuits or information for configuring hardware circuits such as microcode or configuration information for an FPGA or other PLD.

The input/output (“I/O”) interface 450 may be configured to couple to one or more external devices, to receive data from the one or more external devices, and to send data to the one or more external devices. Such external devices along with the various internal devices may also be known as peripheral devices. The I/O interface 450 may include both electrical and physical connections for coupling the various peripheral devices to the computing machine 400 or the processor 410. The I/O interface 450 may be configured to communicate data, addresses, and control signals between the peripheral devices, the computing machine 400, or the processor 410. The I/O interface 450 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 450 may be configured to implement only one interface or bus technology. Alternatively, the I/O interface 450 may be configured to implement multiple interfaces or bus technologies. The I/O interface 450 may be configured as part of, all of, or to operate in conjunction with, the system bus 420. The I/O interface 450 may include one or more buffers for buffering transmissions between one or more external devices, internal devices, the computing machine 400, or the processor 410.

The I/O interface 450 may couple the computing machine 400 to various input devices including mice, touch-screens, scanners, electronic digitizers, sensors, receivers, touchpads, trackballs, cameras, microphones, keyboards, any other pointing devices, or any combinations thereof. The I/O interface 450 may couple the computing machine 400 to various output devices including video displays, speakers, printers, projectors, tactile feedback devices, automation control, robotic components, actuators, motors, fans, solenoids, valves, pumps, transmitters, signal emitters, lights, and so forth.

The computing machine 400 may operate in a networked environment using logical connections through the network interface 460 to one or more other systems or computing machines across the network 470. The network 470 may include wide area networks (WAN), local area networks (LAN), intranets, the Internet, wireless access networks, wired networks, mobile networks, telephone networks, optical networks, or combinations thereof. The network 470 may be packet switched, circuit switched, of any topology, and may use any communication protocol. Communication links within the network 470 may involve various digital or an analog communication media such as fiber optic cables, free-space optics, waveguides, electrical conductors, wireless links, antennas, radio-frequency communications, and so forth.

The processor 410 may be connected to the other elements of the computing machine 400 or the various peripherals discussed herein through the system bus 420. It should be appreciated that the system bus 420 may be within the processor 410, outside the processor 410, or both. According to some embodiments, any of the processor 410, the other elements of the computing machine 400, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. An artist artwork authentication and artist information system to manage, authenticate, and provide artist and artwork information of public artworks, comprising:
a storage resource; and
a processor communicatively coupled to the storage resource, wherein the processor executes application code instruction that are stored in the storage resource to cause the system to:
interface with a 3rd party application that converts processed image data to text form;
receive central authority registration information that includes a registered domain name and an artist artwork unique identifier from the 3rd party application;
store in a database the registered domain name and the artist artwork unique identifier;
generate a first communications message addressed to a central authority system identified by the registered domain name and that further includes a request for a public key for the central authority system;
communicate the communications message to the central authority system;
receive a communications response message that includes the public key;
encrypt the artist artwork unique identifier generating an encrypted identifier using the public key;
generate a second communications message addressed to the central authority system and include with the message the encrypted identifier;
communicate the second communications message to the central authority system;
receiving from the central authority system information associated with artist and artist artwork identified by the unique identifier; and
display the artist and artwork information.

2. The artist artwork authentication and artist information system of claim 1, execution of the application code instructions further causing the system to receive a location identifier identifying a location of an artist artwork.

3. The artist artwork authentication and artist information system of claim 2, execution of the application code instructions further causing the system to display physical address information associated with the location identifier.

4. The artist artwork authentication and artist information system of claim 1, execution of the application code instructions further causing the system to receive a Universal Resource Locater (URL) identifying a merchant vendor of the published artwork.

5. The artist artwork authentication and artist information system of claim 4, execution of the application code instructions further causing the system to receive artist artwork and artist information from the merchant vendor.

6. The artist artwork authentication and artist information system of claim 1, execution of the application code instructions further causing the system to receive a type of artwork publication identifying the artwork as original or copy.

7. The artist artwork authentication and artist information system of claim 1, execution of the application code instruction further causing the system to automatically receive other relative artworks.

8. The artist artwork authentication and artist information system of claim 7, execution of the application code instruction further causing the system to receive digital images of artworks from the same artist.

9. The artist artwork authentication and artist information system of claim 7, execution of the application code instruction further causing the system to receive digital images of artworks from other artists.

10. A computer program product, comprising:
a non-transitory computer-readable storage device having computer-executable program instructions embodied thereon that when executed by a computer cause the computer to process unique identifiers to verify authenticity of public artworks associated with the unique identifier and provide information associated with the artwork and an artist associated with the artwork, the computer-executable program instructions comprising:
computer-executable program instruction to interface with a 3rd party application that converts processed image data to text form;
computer-executable program instructions to receive central authority registration information that includes a registered domain name and an artist artwork unique identifier from the 3rd party application;
computer-executable program instruction to store in a database the registered domain name and the artist artwork unique identifier;
computer-executable program instruction to generate a first communications message addressed to a central authority system identified by the registered domain name and that further includes a request for a public key for the central authority system;
computer-executable program instruction to communicate the communications message to the central authority system;
computer-executable program instruction to receive a communications response message that includes the public key;
computer-executable program instruction to encrypt the artist artwork unique identifier generating an encrypted identifier using the public key;
computer-executable program instruction to generate a second communications message addressed to the central authority system and include with the message the encrypted identifier;
computer-executable program instruction to communicate the second communications message to the central authority system;
computer-executable program instruction to receive from the central authority system a location identifier identifying a location of an artist artwork; and
computer-executable program instruction to display the artist and artwork information.

11. The computer program product of claim 10, further comprising computer-executable program instructions to receive from the central authority a location identifier identifying a location of an artist artwork.

12. The computer program product of claim 11, further comprising computer-executable program instructions to display physical address information associated with the location identifier.

13. The computer program product of claim 10, further comprising computer-executable program instructions to receive a Universal Resource Locater (URL) identifying a merchant vendor of the published artwork.

14. The computer program product of claim 10, further comprising computer-executable program instructions to receive artist artwork and artist information from the merchant vendor.

15. The computer program product of claim 10, further comprising computer-executable program instructions to receive a type of artwork publication identifying the artwork as original or copy.

16. The computer program product of claim 10, further comprising computer-executable program instructions to automatically receive other relative artworks.

17. The computer program product of claim 10, further comprising computer-executable program instructions to receive digital images of artworks from the same artist.

18. The computer program product of claim 10, further comprising computer-executable program instructions to receive digital images of artworks from other artists.
